(19) United States
(12) Patent Application Publication
(10) Pub. No.: US 2007/0227606 A1
(43) Pub. Date: Oct. 4, 2007

(54) Corrugated Hose for Transporting Fluid and Method for Producing the Same

(76) Inventor: Kazushige Sakazaki, Komaki-shi (JP)

Correspondence Address: Joseph J. Jochman;Andrus, Sceales, Starke & Sawall, LLP, Suite 1100, 100 East Wisconsin Avenue, Milwaukee, WI, 53202-4178, US

(21) Appl. No.: 11/692,217

(22) Filed: Mar. 28, 2007

(30) Foreign Application Priority Data
Mar. 28, 2006 (JP) 2006-089389
Mar. 23, 2007 (JP) 2007-076463

(51) Int. Cl. F16L 11/00

(52) U.S. Cl. 138/121; 138/126; 138/125; 138/177

(57) ABSTRACT

A corrugated hose for transporting a fluid has a multilayer construction including a resin layer as a barrier layer, an inner rubber layer and an outer rubber layer. The corrugated hose has a straight-walled portion, and a corrugated portion including corrugation valleys and corrugation hills, at least on one axial region of the corrugated hose. Each of the corrugation valleys has an inner diameter smaller than an inner diameter of the straight-walled portion, and each of the corrugation hills has an outer diameter equal to or smaller than an outer diameter of the straight-walled portion thereof.

### FIELD OF THE INVENTION

The present invention relates to a corrugated hose for transporting a fluid having at least one corrugated portion on an axial region thereof, specifically, a composite corrugated hose for transporting a fluid with multilayer construction including a resin layer having a permeation resistance to a transported fluid in the middle as a barrier layer, and a method for producing the same.

### DESCRIPTION OF THE RELATED ART

For application of a fluid transporting hose, for example, a fuel hose in a motor vehicle, a typical rubber hose made of a blend of acrylonitrile-butadiene rubber and polyvinyl chloride (NBR/PVC blend, NBR+PVC) or the like has been conventionally used. Such rubber hose has a high vibration-absorbability, easiness of assembly, and an excellent permeation resistance to a fuel (gasoline).

However, recently, in view of global environmental conservation, regulations on restriction of permeation of motor vehicle fuel has been tightened, and demand for fuel permeation resistance is expected to increase more and more in future.

As a countermeasure against that, developed and used is a resin composite hose including a resin layer that is laminated as an inner surface layer on an inner side of an outer rubber layer, has an excellent fuel permeation resistance and serves as a barrier layer.

However, the resin layer as the barrier layer is hard since resin is a material harder than rubber. So, in a hose including the resin layer laminated on an inner side of the outer rubber layer to an extreme end thereof (an axial end of the hose), when the hose is fitted on a mating pipe, a sealing property becomes insufficient due to poor bonding between the mating pipe and the resin layer that defines an inner surface of the hose.

And, since the resin layer defining the inner surface of the hose is hard and has a large deformation resistance, a great force is required for fitting or slipping the hose on the mating pipe. This causes a problem that easiness of connection of the hose and the mating pipe is impaired.

For the purpose of solution of the problem, a hose as shown in FIG. 8 is disclosed in Patent Document 1 below.

In the Figure, reference numeral 200 indicates a resin composite hose, reference numeral 202 indicates an outer rubber layer, and reference numeral 204 is a resin layer that is laminated on an inner surface of the outer rubber layer 202 as a barrier layer.

In the resin composite hose 200, on an end portion thereof to be connected to a mating pipe 206 made of metal, the resin layer 204 is not laminated, and an inner surface of the outer rubber layer 202 is exposed so as to be fitted on the mating pipe 206 directly and elastically in contact relation.

And, in order to prevent a problem that a fuel flowing inside penetrates between the exposed inner surface of the outer rubber layer 202 and the mating pipe 206, and permeates outside through the end portion of the outer rubber layer 202 on which the resin layer 204 is not laminated, in the resin composite hose 200, an annular grooved portion 208 is formed in an end portion of the resin layer 204, a ring-shaped elastic sealing member 210 made of a material such as fluoro rubber (FKM), and having high fuel permeation resistance is attached therein. The resin composite hose 200 is fitted on the mating pipe 206 so as to elastically contact an inner surface of the elastic sealing member 210 with the mating pipe 206.

Meanwhile, reference numeral 212 indicates a bulge portion bulging annularly in a radially outward direction on a leading end portion of the mating pipe 206, reference numeral 214 indicates a hose clamp for fixing the end portion of the outer rubber layer 202 on the mating pipe 206 by tightening in a diametrically contracting direction an outer peripheral surface of the end portion of the outer rubber layer 202 on which the resin layer 204 is not laminated.

In the resin composite hose 200 shown in FIG. 8, the resin layer 204 is not laminated on an end portion of the resin composite hose 200. Therefore, a great resistance is not exerted by the resin layer 204 when the resin composite hose 200 is fitted on the mating pipe 206, and thereby the resin composite hose 200 can be fitted thereon easily with a small force.

And, in the end portion of the resin composite hose 200, the inner surface of the outer rubber layer 202 having elasticity contacts directly with the mating pipe 206, and a good sealing property can be provided between the mating pipe 206 and a portion of the resin composite hose 200 fitted thereon.

By the way, the fuel hose typically has a predetermined curved shape since the fuel hose has to be arranged so as not to interfere with peripheral parts and components.

A typical rubber hose of such curved shape is produced in a following manner as disclosed in Patent Document 2 below. An elongated and straight tubular rubber hose body is formed by extrusion, and the elongated and straight tubular rubber hose body is cut to a predetermined length to obtain a straight tubular rubber hose body 216 that is not vulcanized (or is semivulcanized). Then, as shown in FIG. 9, the straight tubular rubber hose body 216 is fitted on a mandrel 218 that is made of metal and has a predetermined curved shape to be deformed into a curved shape. Before molding or fitting, a mold release agent is applied to a surface of the mandrel 218. The curved tubular rubber hose body is vulcanized with being fitted on the mandrel 218 by heating for a predetermined time. When vulcanization is completed, the hose 220 of curved shape is removed from the mandrel 218, and washed, thereby the hose 220 of curved shape as a finished product can be obtained.

However, in case of the resin composite hose 200 shown in FIG. 8, such production method cannot be employed. In case of the resin composite hose 200 shown in FIG. 8, first of all, the outer rubber layer 202 is solely formed by injection molding, and the resin layer 204 is formed on the inner surface of the outer rubber layer 202 so as to follow a shape of the inner surface thereof.

For formation of the resin layer 204 so as to follow the shape of the inner surface of the outer rubber layer 202, electrostatic coating means is suitably applied.

The electrostatic coating is applied in such manner that an injection nozzle is inserted inside a hose, specifically inside the outer rubber layer 202, and resin powder is sprayed from the injection nozzle onto an inner surface of the hose, thereby the inner surface of the outer rubber layer 202 is electrostatically coated with the resin powder.

In the electrostatic coating, a resin membrane is formed in such manner that negatively or positively charged resin powder (typically, negatively charged resin powder) is sprayed from the injection nozzle, and the resin powder flies to and is attached to the inner surface of the outer rubber layer 202 as counter electrode (positive electrode) by electrostatic field.

In steps of such an electrostatic coating, in order to form the resin layer 204 with an intended thickness, usually, more than one cycles of electrostatic coating are performed. Specifically, after the resin powder is attached on the inner surface of the outer rubber layer 202, the resin powder is melted by heating and then cooled. Then, another resin powder is attached on the resin powder by further spraying the resin powder thereto by an electrostatic coating and the another resin powder is melted by heating and then cooled. In this manner, the cycle of electrostatic coating is repeated until the resin layer 204 with an intended wall thickness is formed.

In this case, overall production steps are as follows.

First, the outer rubber layer 202 is formed by injection molding. Then, the outer rubber layer 202 is dried, washed in pretreatment process and dried again. Subsequently, resin powder is attached to an inner surface of the outer rubber layer 202 by electrostatic coating. The resin powder thereon is melted by heating and then cooled. After that, a second cycle of the electrostatic coating (attaching by electrostatic coating, melting and cooling of resin powder) is performed, and this cycle (attaching by electrostatic coating, melting and cooling of resin powder) is repeated to obtain the resin layer 204 with the intended wall-thickness. After the resin layer 204 is completed, a ring-shaped elastic sealing member 210 having fuel permeation resistance is inserted through an axial end of the outer rubber layer 202 to be placed in a predetermined position.

As stated above, a number of steps are required for producing the resin composite hose 200 shown in FIG. 8, and therefore, production cost of the resin composite hose 200 is necessarily increased.

Although the above are described with reference to a fuel hose as an example. The similar problems are anticipated in common to any resin composite hose including a resin layer that defines an inner surface layer on inner side of an outer rubber layer in order to prevent permeation of a transported fluid and serves as a barrier layer having a permeation resistance to the transported fluid.

Accordingly, the inventors of the present invention devised a resin composite hose of a multilayer construction in which an inner rubber layer is further laminated on an inner side of a resin layer as an inner surface layer.

The resin composite hose of the multilayer construction can be provided with permeation resistance (barrier property) to a transported fluid by the resin layer. Further, the inner rubber layer that defines an inner surface of the resin composite hose is elastically deformed when the resin composite hose is fitted on a mating pipe, thereby allows a worker to easily fit the resin composite hose on the mating pipe with a small force, namely to easily connect the resin composite hose to the mating pipe with a small force.

And, since the resin composite hose is connected to the mating pipe so as to elastically contact the inner rubber layer with the mating pipe, a good sealing property can be provided between the mating pipe and a portion of the resin composite hose connected thereto.

And, in the resin composite hose of the multilayer construction, since the resin layer can be formed to an axial edge of the hose, an expensive ring-shaped sealing member 210 having high permeation resistance to a transported fluid as shown in FIG. 8 can be omitted.

In addition, in the resin composite hose of the multilayer construction, since the resin layer can be formed to the axial edge of the hose, it becomes possible to produce the resin composite hose that has a curved shape in the same production method as shown in FIG. 9.

Specifically, a straight tubular hose body is formed with a multilayer construction by successively laminating the inner rubber layer, the resin layer and the outer rubber layer one on another by extrusion. The straight tubular hose body is unvulcanized or semivulcanized. Then, the straight tubular hose body is fitted on a mandrel that has a predetermined curved shape to be deformed, the curved tubular hose body with being fitted on the mandrel is vulcanized by heating, and thereby a resin composite hose of curved shape can be obtained.

In this production method, it becomes possible to produce a resin composite hose at much lower cost than before.

Meanwhile, a fluid transporting hose for a motor vehicle bears a function of absorbing vibration. And, the fluid transporting hose for a motor vehicle is required to be assembled easily in a motor vehicle, and to be elongated for absorbing a shock in car collision. In these points of view, in many cases, it is necessary to form a corrugated portion on the fluid transporting hose.

For example, one method for forming a corrugated portion on a hose is disclosed in Patent Document 2 below.

However, in the method disclosed in Patent Document 2, hill portions of a corrugated molding portion of a mandrel project radially outwardly with respect to an outer surface (outer diameter) of a straight-walled portion of the mandrel, namely, an outer diameter of the hill portions is greater than that of the straight-walled portion. When an unvulcanized or semivulcanized tubular hose body of straight-walled shape is tried to be relatively fitted on such mandrel in an axial direction, the radially outwardly projecting hill portions impede fitting of the tubular hose body and provide a large resistance during fitting of the tubular hose body. And, thereby it becomes considerably difficult to fit the tubular hose body on the mandrel.

And, since the tubular hose body that has passed over the hill portions of the corrugated molding portion of the mandrel is diametrically expansively deformed by the hill portions, the tubular hose body is not diametrically contracted sufficiently to return to its original size after passing over the hill portions. Therefore, it is difficult to form a corrugated hose successfully or favorably in a required shape and size.

[Patent Document 1] JP-A, 2002-54779

[Patent Document 2] JP-A, 11-90993

Under the foregoing circumstances, it is an object of the present invention to provide a corrugated hose for transporting a fluid as a resin composite hose with a middle resin layer that can be successfully or favorably formed with a corrugated portion and be produced efficiently at low cost as a whole, and a method for producing the resin composite hose.

### SUMMARY OF THE INVENTION

According to the present invention, there is provided a novel corrugated hose for transporting a fluid. The corrugated hose for transporting a fluid with a multilayer construction includes a resin layer having permeation resistance to a transported fluid and serving as a barrier layer, an inner rubber layer as an inner surface layer laminated on an inner side of the resin layer and an outer rubber layer laminated on an outer side of the resin layer. The corrugated hose comprises a straight-walled portion, and a corrugated portion including corrugation valleys and corrugation hills, at least on one axial region of the corrugated hose. Each of the corrugation valleys has an inner diameter smaller than an inner diameter of the straight-walled portion, and each of the corrugation hills has an outer diameter equal to or smaller than an outer diameter of the straight-walled portion thereof, or not greater than an outer diameter of the straight-walled portion thereof.

According to one aspect of the present invention, a curved portion is provided at least on one axial region of the corrugated hose.

According to the present invention, there is provided a novel method for producing the corrugated hose for transporting a fluid as stated above. The method for producing the corrugated hose of the present invention comprises a step of forming a tubular hose body of a straight-walled shape with a multilayer construction by successively laminating the inner rubber layer, the resin layer and the outer rubber layer on one another by extrusion, and a step of preparing a mandrel having a corrugated molding portion for the corrugated portion that includes hill portions for the corrugation hills and valley portions for the corrugation valleys. The tubular hose body of the straight-walled shape is unvulcanized or semivulcanized and plastically deformable. The hill portions are of an outer diameter equal to or smaller than an inner diameter of the tubular hose body of the straight-walled shape, or not greater than an inner diameter of the tubular hose body of the straight-walled shape, and the valley portions are of an outer diameter smaller than the inner diameter of the tubular hose body of the straight-walled shape. The method further comprises a step of relatively fitting the tubular hose body of the straight-walled shape on the mandrel, a step of deforming a portion of the tubular hose body corresponding to the corrugated molding portion into a shape following a contour of the corrugated molding portion to obtain a tubular hose body including the corrugated portion, and a step of vulcanizing the tubular hose body including the corrugated potion to obtain the corrugated hose.

According to one aspect of the method for producing the corrugated hose of the present invention, an outer mold including a corrugated molding part of a shape corresponding to the contour of the corrugated molding portion of the mandrel is prepared. The outer mold is pressed radially inwardly onto the tubular hose body fitted on the mandrel so as to sandwich the tubular hose body between the outer mold and the mandrel, and thereby the tubular hose body is deformed in a shape following contours of the corrugated molding portion of the mandrel and the corrugated molding part of the outer mold, and the tubular hose body together with the mandrel and the outer mold is vulcanized to obtain the corrugated hose.

According to one aspect of the method for producing the corrugated hose of the present invention, the mandrel is hollowed out, the mandrel is formed with suction channels provided radially through the corrugated molding portion for communication between a hollow portion of the mandrel and an inside of the tubular hose body fitted on the mandrel, a negative pressure is applied to the tubular hose body through the hollow portion and the suction channels so as to suction or attract the tubular hose body onto the mandrel to deform the tubular hose body into a shape following the contour of the corrugated molding portion of the mandrel, and the tubular hose body while being suctioned or attracted on the mandrel is vulcanized to obtain the corrugated hose.

As stated above, in the corrugated hose for transporting a fluid according to the present invention, each of the corrugation valleys of the corrugated portion has an inner diameter smaller than an inner diameter of the straight-walled portion, and each of the corrugation hills of the corrugated portion has an outer diameter equal to or smaller than an outer diameter of the straight-walled portion. Therefore, in a production process of the corrugated hose according to the present invention, an unvulcanized tubular hose body (or semivulcanized tubular hose body, hereinafter an explanation on an unvulcanized tubular hose body shall cover a semivulcanized tubular hose body) to of the straight-walled shape can be relatively fitted on the mandrel smoothly without bearing a resistance from the corrugated molding portion formed on the mandrel.

And, after fitting the tubular hose body on the mandrel, a portion of the tubular hose body is deformed into a shape following the contour of the corrugated molding portion of the mandrel and thereby the corrugated hose including the corrugated portion as desired can be obtained.

In other words, according to the present invention, since the corrugated hose can be formed with use of a mandrel, a production cost therefor can be reduced.

The present invention can be applied to a corrugated hose of a straight shape for transporting a fluid. However, the present invention produces a large effect, in particular when applied to a corrugated hose provided with a curve portion at least on an axial region thereof. Even for the corrugated hose with the curved portion, a corrugated portion or the curved portion can be easily formed also with use of a mandrel.

In the method for producing the corrugated hose according to the present invention, an unvulcanized tubular hose body of a straight-walled shape with a multilayer construction is formed by laminating successively an inner rubber layer, a resin layer and an outer rubber layer on one another by extrusion, the tubular hose body is fitted on a mandrel and deformed, and then the deformed tubular hose body with the mandrel is vulcanized.

In the present invention, the mandrel is formed with a corrugated molding portion, the tubular hose body of the straight-walled shape is fitted on such a mandrel and deformed, and the deformed tubular hose body is vulcanized.

Here, in the corrugated molding portion of the mandrel, each of the hill portions has an outer diameter equal to or smaller than an inner diameter of the tubular hose body of the straight-walled shape, and each of the valley portions has an outer diameter smaller than the inner diameter of the tubular hose body of the straight-walled shape.

In this configuration, since the outer diameter of the hill portions of the corrugated molding portion is not greater than the inner diameter of the tubular hose body of the straight-walled shape, the hill portions of the corrugated molding portion do not impede fitting of the tubular hose body, therefore, the tubular hose body can be fitted on the mandrel smoothly without bearing a resistance from the corrugated molding portion.

And, in a conventional method for formation of the corrugated portion on the tubular hose body, a problem is that the tubular hose body that has passed over the hill portions of the corrugated molding portion of the mandrel at fitting operation is diametrically expansively deformed by the hill portions, and is not diametrically contracted sufficiently to return to its original size. However, such problem is not caused in the present invention.

Namely, in the present invention, the tubular hose body fitted on the mandrel is deformed into a shape following the contour of the corrugated molding portion, and the corrugated portion can be successfully or favorably formed on the tubular hose body.

According to one aspect of the present invention, an outer mold may be used for formation of the corrugated portion on the tubular hose body fitted on the mandrel with the corrugated molding portion. The outer mold is formed with a corrugated molding part of a shape corresponding to a contour of the corrugated molding portion of the mandrel. The outer mold is pressed radially inwardly onto the tubular hose body so as to sandwich the tubular hose body between the outer mold and the mandrel, and thereby the tubular hose body is deformed in a shape following contours of the corrugated molding portion of the mandrel and the corrugated molding part of the outer mold, and the tubular hose body together with the mandrel and the outer mold is vulcanized. In the method according to the present invention, the corrugated portion can be successfully formed on the tubular hose body.

On the other hand, in the method for producing the corrugated hose according to one aspect of the present invention, another configuration of the mandrel may be used. The mandrel is hollowed out, and has suction channels provided radially through the corrugated molding portion for communication between a hollow portion of the mandrel and an inside of the tubular hose body fitted on the mandrel. And the tubular hose body is suctioned radially inwardly through the suction channels to be deformed into a shape following the contour of the corrugated molding portion of the mandrel, thereby the corrugated portion is formed on the tubular hose body. In this production method, the corrugated portion can be formed successfully or favorably in a certain region of the tubular hose body.

Now, the preferred embodiments of the present invention will be described in detail with reference to the drawings.

### BRIEF DESCRIPTION OF THE DRAWINGS

FIG. 1A is a side view, partly broken away, of a corrugated hose for transporting a fluid according to one embodiment of the present invention.

FIG. 1B is a perspective view of the corrugated hose of FIG. 1A.

FIG. 2 is a sectional view of a relevant part of the corrugated hose of FIG. 1A.

FIG. 3A is a view for explaining a relevant step of a method for producing the corrugated hose of FIG. 1A.

FIG. 3B is a view for explaining a subsequent step of FIG. 3A.

FIG. 4A is a view for explaining a relevant step of a method for producing the corrugated hose with use of an outer mold.

FIG. 4B is a view for explaining a subsequent step of FIG. 4A.

FIG. 5A is a view for explaining a relevant step of a method for producing the corrugated hose with use of a hollow mandrel.

FIG. 5B is a view for explaining a subsequent step of FIG. 5A.

FIG. 6 is a perspective view of a modified corrugated hose for transporting a fluid according to the present invention.

FIG. 7 is a perspective view of another modified corrugated hose for transporting a fluid according to the present invention.

FIG. 8A is a sectional view of a conventional resin composite hose.

FIG. 8B is an enlarged view of a part of the conventional resin composite hose of FIG. 8A.

FIG. 9 is a view showing a typical production method for producing a conventional resin composite hose including a curved portion.

### DETAILED DESCRIPTIONS OF PREFERRED EMBODIMENTS

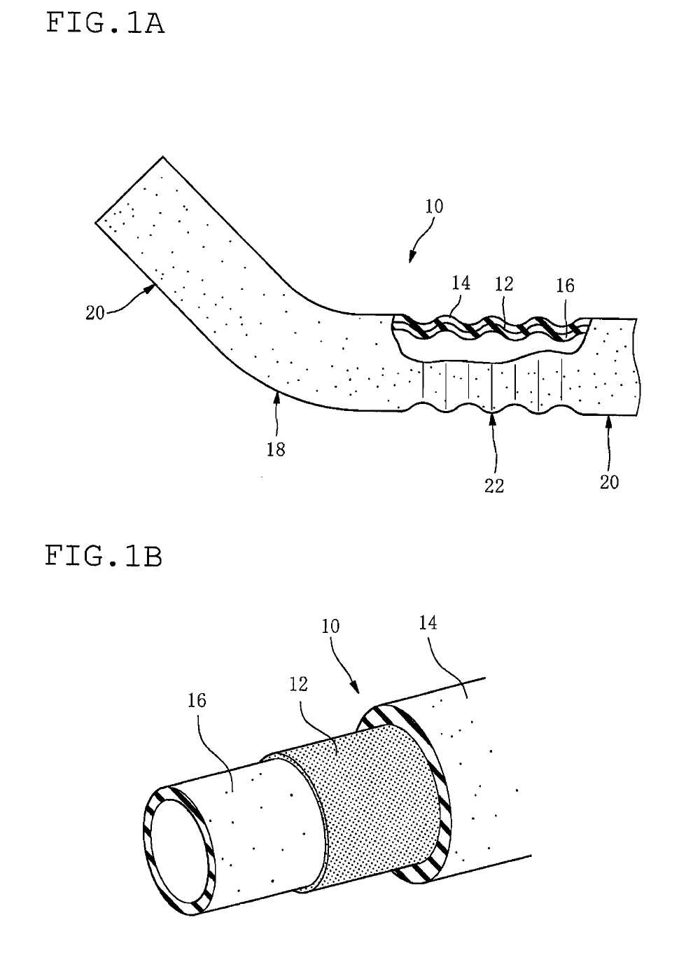

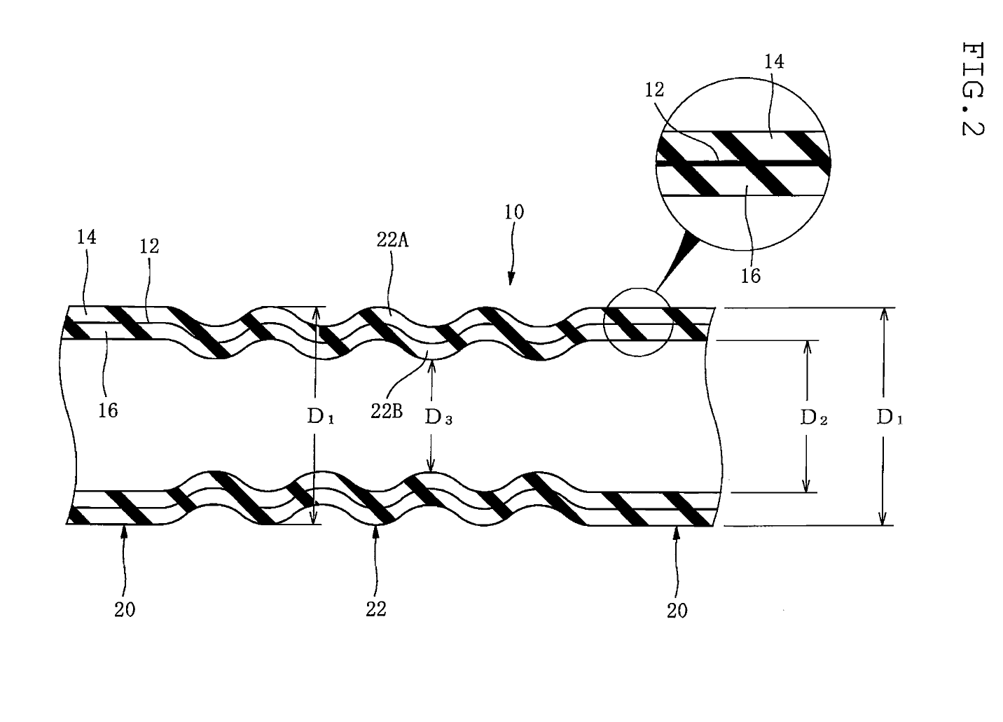

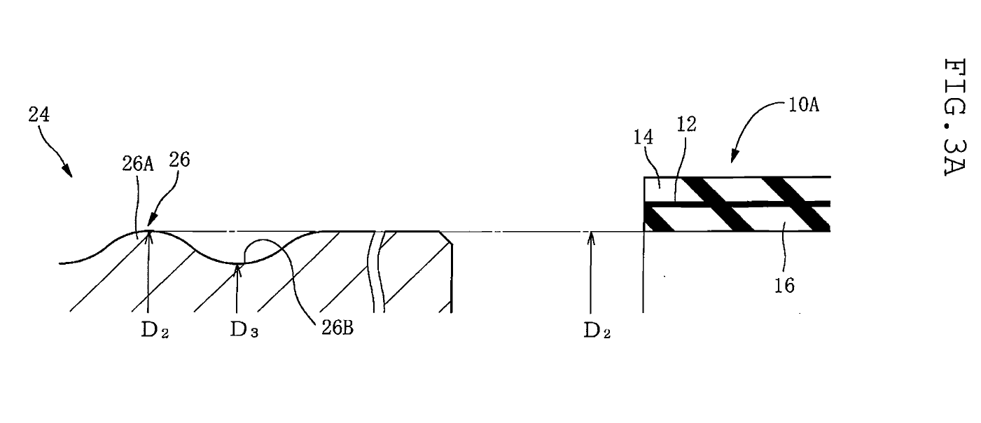

In FIGS. 1 and 2, numeral reference 10 indicates a corrugated hose for transporting a fluid or a fluid transporting corrugated hose (hereinafter simply referred to as a hose) that is suitable for a hose such as a fuel hose (filler hose) for transporting a fuel injected in a fuel inlet to a fuel tank in a motor vehicle. The hose 10 has a multilayered construction comprising a resin layer 12 as a barrier layer having a permeation resistance to a transported fluid, an outer rubber layer 14 on an outer side of the resin layer 12, and an inner rubber layer 16 as an inner surface layer on an inner side of the resin layer 12.

Here, the resin layer 12 constituting a middle layer extends through an entire length of the hose, from one end to the other end in an axial direction of the hose 10.

In this embodiment, the inner rubber layer 16 is made of acrylonitrile butadiene rubber (NBR), the resin layer 12 is made of fluorothermoplastic copolymer consisting of at least three monomers, tetrafluoroethylene, hexafluoropropylene, and vinylidene fluoride (THV), and the outer rubber layer 14 is made of NBR+polyvinyl chloride (PVC).

Here, a bonding strength between the layer and an adjacent layer exceeds 10N/25 mm, and the layers are bonded to each other firmly. In each of samples evaluated with respect to bonding strength, peel-off does not occur on an interface of each layer, but a parent material is destroyed. The resin layer 12 and the inner rubber layer 16, the resin layer 12 and the outer rubber layer 14 are bonded to one another by vulcanizing bonding, but may be also bonded to one another by adhesive.

The inner rubber layer 16, the resin layer 12 and the outer rubber layer 14 are made or constructed of the following materials, besides the combination of the above materials.

Specifically, for the inner rubber layer 16, materials such as NBR (acrylonitrile content is equal to or greater than 30% by mass), NBR+PVC (acrylonitrile content is equal to or greater than 30% by mass), FKM, hydrogenated acrylonitrile butadiene rubber (H-NBR) are suitable.

A wall-thickness of the inner rubber layer 16 may be about 1.0 to 2.5 mm.

For the resin layer 12 as a middle layer, materials such as THV, polyvinylidene fluoride (PVDF), ethylene-tetrafluoroethylene (ETFE), polychlorotrifluoroethylene (CTFE), polyethylene vinyl alcohol (EVOH), polybutylene naphthalate (PBN) polybutylene terephtharate (PBT), polyphenylene sulfide (PPS) are preferably used.

A wall thickness of the resin layer 12 may be about 0.03 to 0.3 mm.

THV is flexible compared to EVOH and PVDF, and suitable for barrier material for a hose with multi-layered combinations of resin and rubber. In comparison with Polytetrafluoroethylene (PTFE) and EVOH, EIFE and THV are easily extruded, easily laminated to a rubber, and have excellent adhesion to rubber. On the other hand, PBN and PBT are less flexible compared to THV. However, PBN and PBT are excellent in fuel permeation resistance, and can be thin-walled compared to THV. Therefore, a flexible hose can be formed also from PBN and PBT.

For the outer rubber layer 14, materials such as NBR+PVC, epichlorohydrin and ethylene oxide copolymer (ECO), chlorosulponated polyethylene rubber (CSM), NBR+acrylic rubber (NBR+ACM), NBR+ethylene propylene diene rubber (NBR+EPDM), and EPDM can be suitably used.

A wall thickness of the outer rubber layer 14 may be about 1.0 to 3.0 mm.

The hose 10 has a curved shape, namely has a curved portion at a certain region in an axial direction of the hose 10. Reference numeral 18 indicates the curved portion in FIG. 1(A).

Reference numeral 20 indicates a straight-walled portion that extends straight in the axial direction of the hose 10.

As shown in Figures, the hose 10 has the straight-walled portion 20 on each axial end portion or region thereof.

And, the hose 10 also has a corrugated portion 22 on a certain axial portion or region thereof.

In a typical hose including a straight-walled portion and a corrugated portion, a corrugation hill of the corrugated portion protrudes radially outwardly with respect to an outer peripheral surface of the straight-walled portion, namely a maximum outer diameter of the corrugated portion is greater than an outer diameter of the straight-walled portion. However, in this embodiment, as shown in FIG. 2, the corrugation hill 22A of the corrugated portion 22 has an outer diameter of a value D₁ that is the same value as an outer diameter of the straight-walled portion 20.

A corrugation valley 22B has an inner diameter of a value D₃ that is smaller than a value D₂ of the inner diameter of the straight-walled portion 20.

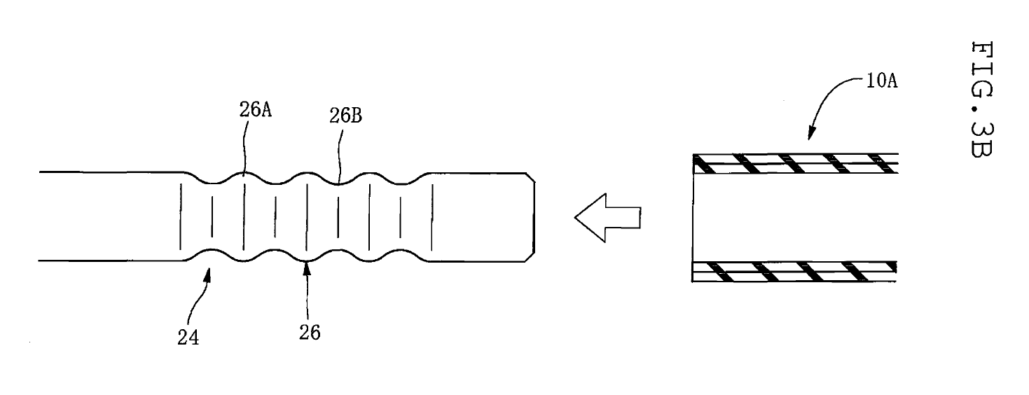

FIG. 3 shows a relevant steps of a method for producing the above hose 10.

In the Figure, reference numeral 24 indicates a metal mandrel. The mandrel has an outer surface of a shape corresponding to a contour of an inner surface of the hose 10.

As shown in the Figure, the mandrel 24 has a corrugated molding portion 26.

Here, the corrugated molding portion 26 has a hill portion 26A and a valley portion 26B. The hill portion 26A has an outer diameter of the value D₂ that is the same value as the inner diameter of the straight-walled portion 20 in the hose 10, while the valley portion 26B has an outer diameter of the value D₃ that is smaller than the value D₂.

In the production method in FIG. 3, first, the inner rubber layer 16, the resin layer 12 and the outer rubber layer 14 are successively laminated on one another by extrusion to obtain an elongated straight tubular body. The elongated straight tubular body is cut to a certain length, and thereby a tubular hose body of the straight-walled shape 10A that is plastically deformable and unvulcanized is obtained.

The tubular hose body of the straight-walled shape 10A may be semi-vulcanized afterward.

Then, the tubular hose body 10A as formed in this manner is fitted on the mandrel 24 and is deformed into a shape following a contour of the mandrel 24, and a curved portion 18 shown in FIG. 1 is formed.

Subsequently, a portion of the tubular hose body 10A corresponding to the corrugated molding portion 26 of the mandrel 24 is deformed into a shape following a contour of the corrugation molding portion 26, thereby the corrugated portion 22 is formed.

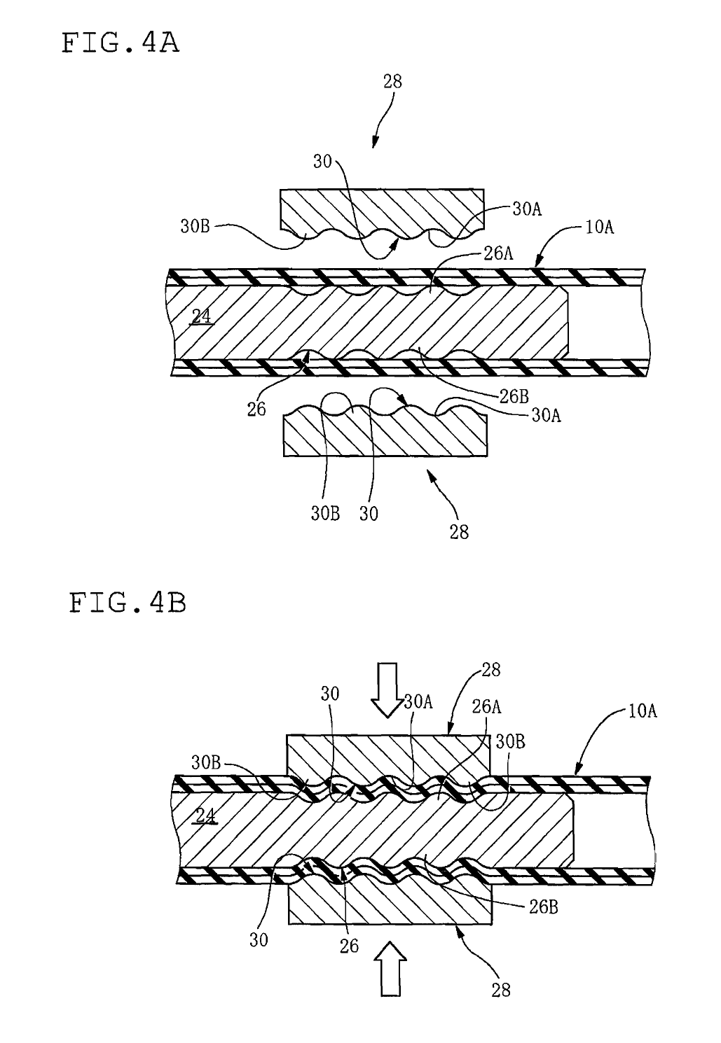

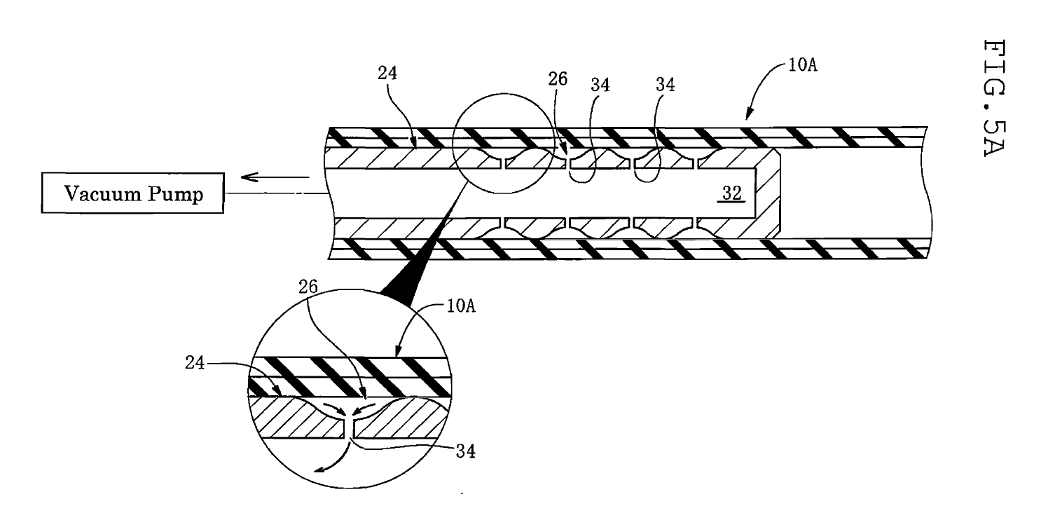

The corrugated portion 22 may be formed in a method shown in FIG. 4.

In FIG. 4, reference numeral 28 indicates an outer mold that includes an corrugated molding part 30 opposite to the tubular hose body 10A, namely the mandrel 24.

In the Figure, reference numeral 30A indicates a valley part for forming the corrugation hill 22A of the corrugated portion 22, and reference numeral 30B indicates a hill part for forming the corrugation valley 22B of the corrugated portion 22.

In the method shown in FIG. 4, the outer mold 28 is pressed radially inwardly onto the tubular hose body 10A that is fitted on the mandrel 24, a portion of the tubular hose body 10A corresponding the corrugated molding portion 26 and the corrugated molding part 30 is sandwiched by and between the corrugated molding portion 26 of the mandrel 24 and the corrugated molding part 30 of the outer mold 28. The portion of the tubular hose body 10A is deformed into a shape following contours of the corrugated molding portion 26 and the corrugated molding part 30 to form the corrugated portion 22 in the tubular hose body 10A (refer to FIG. 4B). Thereby the tubular hose body 10A including the corrugated portion 22 is obtained.

Then, the tubular hose body 10A together with the mandrel 24 and the outer mold 28 is vulcanized by heating for a predetermined time to obtain a vulcanized corrugated tubular hose body (the corrugated hose 10). After that, the outer mold 28 is opened and removed from the vulcanized corrugated tubular hose body, and the mandrel 24 is removed from the vulcanized corrugated tubular hose body. Then obtained is the hose 10 of multilayer construction including the resin layer, having the curved shape and the corrugated portion 22 as shown in FIG. 1.

In this embodiment as stated above, in steps for producing the hose 10, the unvulcanized tubular hose body of a straight-walled shape 10A can be relatively fitted on the mandrel 24 smoothly without bearing considerable resistance from the corrugated molding portion 26 of the mandrel 24.

After that, the tubular hose body 10A is deformed into a shape following a contour of the corrugated molding portion 26 of the mandrel 24, and thereby the fluid transporting corrugated hose 10 including the corrugated portion 22 as required can be obtained.

That is, for producing the hose 10, it becomes possible to mold the hose 10 with use of such mandrel 24, and thus a cost required for producing the hose 10 can be reduced.

And, according to the present embodiment, it becomes possible to produce even the hose 10 including the curved portion 18 with use of the mandrel 24.

In this embodiment, since an outer diameter of the hill portion 26A of the corrugated molding portion 26 does not exceed an inner diameter of the tubular hose body of a straight-walled shape 10A, the tubular hose body 10A can be relatively fitted on the mandrel 24 smoothly without bearing considerable resistance from the corrugated molding portion 26.

A conventional production method entails a problem when the tubular hose body 10A is relatively fitted on the mandrel 24. That is, in the conventional production method, the tubular hose body 10A is diametrically expanded when passing over the hill portions 26A of the corrugated molding portion 26, and is not diametrically contracted to its original shape after passing over them. However, such problem does not arise in the production method as stated above.

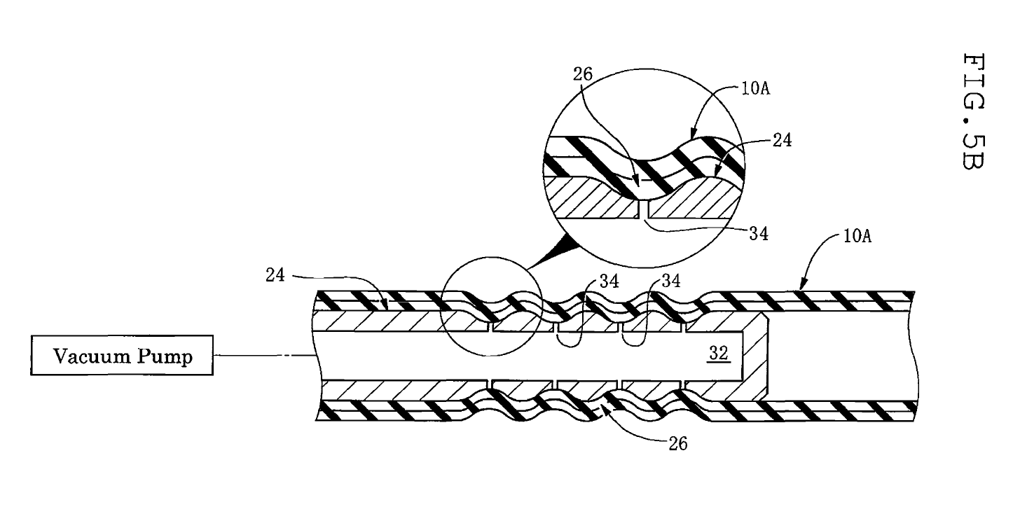

FIG. 5 shows relevant steps for another method for producing the hose 10.

As shown in FIG. 5, in another production method, the mandrel 24 is hollowed out. The mandrel 24 is formed with suction channels 34 for communicating between a hollow portion 32 of the mandrel 24 and an inner side of a portion of the tubular hose body 10A corresponding to the corrugated molding portion 26.

After the tubular hose body 10A is relatively fitted on the mandrel 26, a negative pressure is applied to the tubular hose body 10A through the suction channels 34 to suction the tubular hose body 10A on the corrugated molding portion 26 and deform the tubular hose body 10A into a shape following a contour of the corrugated molding portion 26.

The tubular hose body 10A formed with a corrugated portion or the tubular hose body 10A together with the mandrel 24 is vulcanized by heating for a predetermined time to obtain a vulcanized corrugated tubular hose body having the curved shape, namely the corrugated hose 10 having the curved shape.

A corrugated portion can be favorably formed on a predetermined region of the tubular hose body 10A also in this production method.

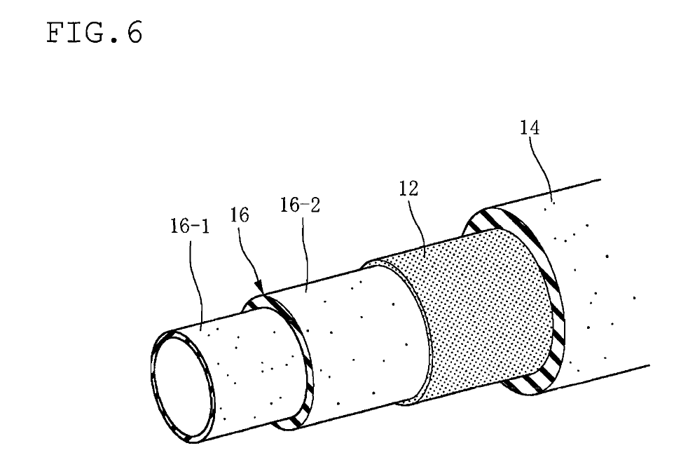

In the hose 10 of the above embodiment, the inner rubber layer 16 comprises a single layer. However, as shown in FIG. 6, the inner layer 16 may have a two-layer construction that comprises a first layer (rubber layer) 16-1 defining an innermost surface and a second layer (rubber layer) 16-2 on an outer side of the first layer 16-1.

In this four-layer hose 10, bonding strength between the layers (one and adjacent layers) is equal to or greater than 10N/25 mm, and the layers are bonded to one another firmly. In each of samples evaluated with respect to bonding strength, peel-off does not occur on an interface of each layer, but a parent material is destroyed. The resin layer 12 and the inner rubber layer 16, the resin layer 12 and the outer rubber layer 14 are bonded to one another by vulcanizing bonding, but may be also bonded to one another by adhesive.

In this four-layer hose 10, a material for each layer may be combined as follows.

For the first layer 16-1, materials such as FKM, NBR (acrylonitrile content is equal to or greater than 30% by mass), NBR+PVC (acrylonitrile content is equal to or greater than 30% by mass) may be suitably used.

A wall-thickness of the first layer 16-1 may be about 0.2 to 1.0 mm.

On the other hand, for the second layer 16-2, materials such as NBR (acrylonitrile content is equal to or greater than 30% by mass) or NBR+PVC (acrylonitrile content is equal to or greater than 30% by mass) may be suitably used.

A wall-thickness of the second layer 16-2 may be about 1 to 2 mm.

The resin layer 12 in the middle of the layers and the outer rubber layer 14 may be formed as stated above.

In particular, preferably, FKM having an excellent gasoline permeation resistance is used for the first layer 16-1. By making the first layer 16-1 of FKM, can be ensured not only a fuel permeation restraining function served by the resin layer 12 but also an end permeation preventing function for effectively preventing that a fuel permeates through an inner surface layer, then permeates out of an axial edge of the hose 10 at an axial end portion of the hose 10 to which a mating member such as a mating pipe is connected. For the purpose of ensuring easy connection of the hose 10 and the mating pipe or the like, the inner rubber layer 16 has a wall-thickness of equal to or greater than 1 mm. However, when the inner rubber layer 16 is entirely made of FKM, a cost of the hose 10 is increased. So, due to cost reason, for the second layer 16-2, inexpensive NBR (acrylonitrile content is equal to or greater than 30% by mass) or inexpensive NBR+PVC (acrylonitrile content is equal to or greater than 30% by mass) is used.

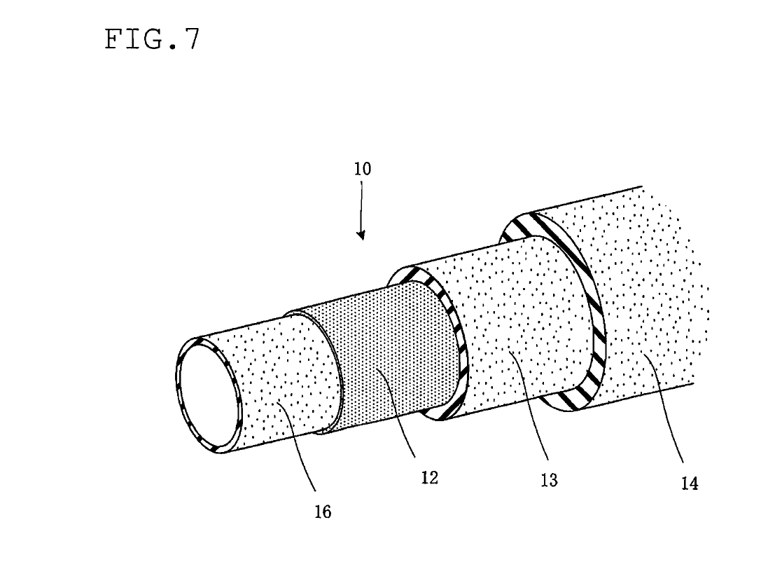

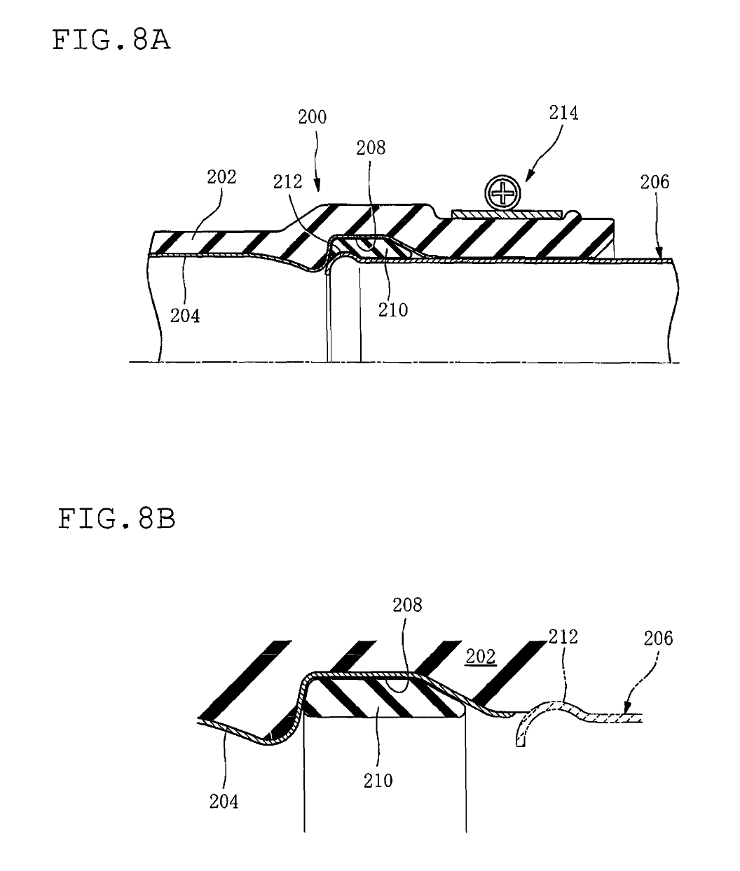

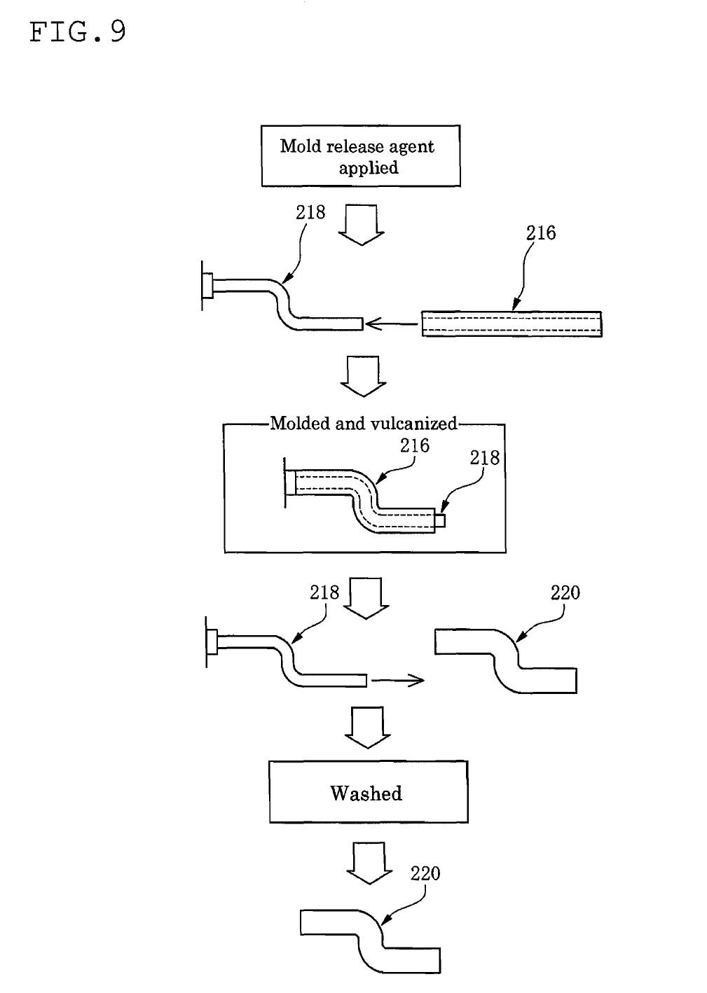

As shown in FIG. 7, the hose 10 may have a multilayer construction including a middle rubber layer 13 between the resin layer 12 and the outer rubber layer 14 (the middle rubber layer 13 may be regarded as a first layer of an outer rubber layer and the outer rubber layer 14 may be regarded as a second layer of the outer rubber layer).

In the hose 10 having the four-layer construction of FIG. 7, bonding strength between the layers (one and adjacent layers) is equal to or greater than 10N/25 mm, and the layers are bonded to one another firmly. In each of samples evaluated with respect to bonding strength, peel-off does not occur on an interface of each layer, but a parent material is destroyed. The resin layer 12 and the inner rubber layer 16, the resin layer 12 and the middle rubber layer 13 are bonded to one another by vulcanizing bonding, respectively, but may be also bonded to one another by adhesive.

In the hose 10 having the four-layer construction of FIG. 7, the inner rubber layer 16, the resin layer 12, the middle rubber layer 13 and the outer rubber layer 14 may be constructed in combination of the following materials.

For the inner rubber layer 16, materials such as FKM, NBR (acrylonitrile content is equal to or greater than 30% by mass), NBR+PVC (acrylonitrile content is equal to or greater than 30% by mass) may be suitably used.

A wall-thickness of the inner rubber layer 16 may be about 0.2 to 1.0 mm.

For the resin layer 12 as a middle layer, fluoro type resin such as THV, PVDF or ETFE, and polyamide (PA) or nylon resin such as PA6, PA66, PA11 or PA12 may be suitably used.

A wall-thickness of the resin layer 12 may be about 0.03 to 0.3 mm.

On the other hand, for the middle rubber layer 13, NBR (acrylonitrile content is equal to or greater than 30% by mass), NBR+PVC (acrylonitrile content is equal to or greater than 30% by mass), ECO, CSM, NBR+ACM, NBR+EPDM, butyl rubber (IIR), EPDM+IIR, or EPDM may be suitably used.

A wall-thickness of the middle rubber layer 13 may be about 0.2 to 2.0 mm.

For the outer rubber layer 14, materials such as NBR (acrylonitrile content is equal to or greater than 30% by mass), NBR+PVC (acrylonitrile content is equal to or greater than 30% by mass), ECO, CSM, NBR+ACM, NBR+EPDM, IIR, EPDM+IIR, and EPDM may be suitably used.

A wall-thickness of the outer rubber layer 14 may be about 1 to 3 mm.

Meanwhile, total wall-thickness, namely a suitable wall-thickness of the hose 10 of FIG. 7 is about 2.5 to 6.0 mm. When the wall-thickness of the hose 10 is less than 2.5 mm, a gasoline permeation resistance of the hose 10 is insufficient. When the wall-thickness of the hose 10 is greater than 6 mm, a flexibility of the hose 10 is insufficient.

Here, when the outer rubber layer 14 (the second layer of the outer rubber layer) or the middle rubber layer 13 (the first layer of the outer rubber layer) is made of IIR or EPDM+IIR, the outer rubber layer 14 or the middle rubber layer 13 is provided with a gasoline fuel permeation resistance, and serves as a barrier layer since IIR and EPDM+IIR have alcohol resistance. Therefore, even when the resin layer 12 is formed thin-walled to enhance flexibility or elasticity of the hose 10, gasoline fuel permeation resistance of the hose 10 does not become insufficient. And, even when the resin layer 12 is made of inexpensive PA or nylon resin instead of fluoro type resin having an excellent gasoline permeation resistance, sufficient gasoline fuel permeation resistance of the hose 10 can be maintained.

Then, the test samples of hoses including middle rubber layers made of IIR are evaluated with respect to a gasoline permeation resistance and the results are shown in Table 1.

The evaluation is conducted in the following manner. Four test samples or specimens of hoses (A), (B), (C) and (D), each having an inner diameter of 24.4 mm, a wall-thickness of 4 mm, and a length of 300 mm, are prepared. The test sample (A) has a three-layer construction including an inner rubber layer of NBR, a resin layer of THV (specifically, THV815: THV815 is a product number of a product commercially available under the trademark Dyneon from Dyneon, LLC), and an outer rubber layer of NBR+PVC, the test sample (B) has a four-layer construction including an inner rubber layer of NBR, a resin layer of THV (THV815, wall-thickness 0.1 mm), a middle rubber layer of IIR (a first layer of an outer rubber layer) and an outer rubber layer of NBR+PVC (a second layer of the outer rubber layer), the test sample (C) has a four-layer construction including an inner rubber layer of NBR, a resin layer of THV (THV815, wall-thickness of 0.08 mm), a middle rubber layer of IIR (a first layer of an outer rubber layer) and an outer rubber layer of NBR+PVC (a second layer of the outer rubber layer), and the test sample (D) has a four-layer construction including an inner rubber layer of NBR, a resin layer of nylon (PA 1), a middle rubber layer of IIR (a first layer of an outer rubber layer) and an outer rubber layer of NBR+PVC (a second layer of the outer rubber layer). In the columns of “Specimen” and “Wall-thickness” of Table 1, materials and wall-thicknesses only of the resin layers and the middle rubber layers (materials and wall-thicknesses only of the resin layer and the outer rubber layer in the test sample (A)) are indicated, respectively. In each of the test samples (A), (B), (C) and (D), a round-chamfered metal pipe of an outer diameter of 25.4 mm provided with two bulge portions (maximum outer diameter of 27.4 mm) is press-fitted in each end portion thereof, and one of the metal pipes is closed with a plug. And, a test fluid (Fuel C+ethanol (E) 10 volume %) is supplied in each of the test samples (A), (B), (C) and (D) via the other of the metal pipes, and the other of the metal pipes is closed with a plug of screw type to enclose the test fluid in each of the test samples (A), (B), (C) and (D). Then, each of the test samples (A), (B), (C) and (D) is allowed to stand at 40° C. for 3000 hours (the test fluid is replaced every 168 hours). Then, permeation amount of carbon hydride (HC) is measured with respect to each of the test samples (A), (B), (C) and (D) every day for three days based on DBL (Diurnal Breathing Loss) pattern by a SHED (Sealed Housing for Evaporative Detection) method according to CARB (California Air Resources Board). With regard to each of the test samples (A), (B), (C) and (D), applied is a permeation amount on a day when a maxim permeation amount is detected.

TABLE 1

| | A | B | C | D |
|---|---|---|---|---|
| Specimen | *¹⁾THV815/ | THV815/IIR | THV815/IIR | PA11/IIR |
| | NBR + PVC | | | |
| Wall-thickness | 0.11/2.16 | 0.11/1.9 | 0.08/1.9 | 0.20/1.9 |
| (mm) | | | | |
| Permeation | 4.2 | 2.7 | 4.2 | 3.8 |
| amount (mg/hose) | | | | |

Note:
*¹⁾THV815 is a product number of THV commercially available under the trademark Dyneon from Dyneon LLC.

As appreciated from the results of Table 1, the permeation amount of HC is the same, namely 4.2 mg/hose, between the test sample (A) including the outer rubber layer made of NBR+PVC and the test sample (C) including the middle rubber layer made of IIR. However, in terms of a wall-thickness of the resin layer, the test sample (A) includes the resin layer of a wall-thickness 0.11 mm that is greater than the wall-thickness 0.08 mm of the test sample (C). Therefore, when a hose includes a rubber layer made of IIR, an equivalent gasoline permeation resistance can be ensured by constructing a resin layer with a wall-thickness decreased by about 30%. Between the test sample (A) including the outer rubber layer made of NBR+PVC and the test sample (B) including the middle rubber layer made of IIR, a wall-thickness of the resin layer is the same, 0.11 mm. However, the permeation amount of HC is different, namely 4.2 mg/hose in the test sample (A) and 2.7 mg/hose in the test sample (B). When a hose includes a resin layer of an identical wall-thickness, HC permeation resistance can be decreased by about 35% by making a rubber layer of IIR. Further, in the test sample (D) including the middle rubber layer made of IIR and the resin layer made of PA11, a permeation amount of HC can be decreased by about 10% compared to the test sample (A) by increasing the wall-thickness of the resin layer by about 80%. This evaluation can basically apply also to a hose including a middle rubber layer made of EPDM+IIR.

As such, when a hose is constructed with four layers by combining materials suitably selected from the above, a permeation resistance to a transported fluid can be further enhanced, a resistance to a sour gasoline can be further enhanced, or a heat resistance or a resistance to alcohol gasoline can be also enhanced in a fuel hose. And, flexibility of the hose can be improved by decreasing a wall-thickness of a resin layer of the hose.

Although the preferred embodiments have been described above, these are only some of embodiments of the present invention. The present invention can be configured and embodied by a variety of modified modes or measures without departing from the scope of the invention.

What is claimed is:

1. A corrugated hose for transporting a fluid with a multilayer construction including a resin layer having permeation resistance to a transported fluid and serving as a barrier layer, an inner rubber layer as an inner surface layer laminated on an inner side of the resin layer and an outer rubber layer laminated on an outer side of the resin layer, the corrugated hose, comprising:
a straight-walled portion, and
a corrugated portion including corrugation valleys and corrugation hills, at least on one axial region of the corrugated hose,
wherein:
each of the corrugation valleys has an inner diameter smaller than an inner diameter of the straight-walled portion, and each of the corrugation hills has an outer diameter equal to or smaller than an outer diameter of the straight-walled portion thereof.

2. The corrugated hose for transporting a fluid as set forth in claim 1, wherein a curved portion is provided at least on one axial region of the corrugated hose.

3. A method for producing the corrugated hose for transporting a fluid as defined in claim 1, comprising:
a step of forming a tubular hose body of a straight-walled shape with a multilayer construction by successively laminating the inner rubber layer, the resin layer and the outer rubber layer on one another by extrusion, the tubular hose body of the straight-walled shape being unvulcanized or semivulcanized and plastically deformable,
a step of preparing a mandrel having a corrugated molding portion for the corrugated portion, the corrugated molding portion including hill portions for the corrugation hills and valley portions for the corrugation valleys, the hill portions being of an outer diameter equal to or smaller than an inner diameter of the tubular hose body of the straight-walled shape, the valley portions being of an outer diameter smaller than the inner diameter of the tubular hose body of the straight-walled shape,
a step of relatively fitting the tubular hose body of the straight-walled shape on the mandrel,
a step of deforming a portion of the tubular hose body corresponding to the corrugated molding portion into a shape following a contour of the corrugated molding portion to obtain a tubular hose body including the corrugated portion, and
a step of vulcanizing the tubular hose body including the corrugated potion to obtain the corrugated hose.

4. The method for producing the corrugated hose for transporting a fluid as set forth in claim 3, wherein an outer mold including a corrugated molding part of a shape corresponding to the contour of the corrugated molding portion of the mandrel is prepared, the outer mold is pressed radially inwardly onto the tubular hose body fitted on the mandrel so as to sandwich the tubular hose body between the outer mold and the mandrel, and thereby the tubular hose body is deformed in a shape following contours of the corrugated molding portion of the mandrel and the corrugated molding part of the outer mold, and the tubular hose body together with the mandrel and the outer mold is vulcanized to obtain the corrugated hose.

5. The method for producing the corrugated hose for transporting a fluid as set forth in claim 3, wherein the mandrel is hollowed out, the mandrel is formed with suction channels provided radially through the corrugated molding portion for communication between a hollow portion of the mandrel and an inside of the tubular hose body fitted on the mandrel, a negative pressure is applied to the tubular hose body through the hollow portion and the suction channels so as to suction the tubular hose body onto the mandrel to deform the tubular hose body into a shape following the contour of the corrugated molding portion of the mandrel, and the tubular hose body while being suctioned on the mandrel is vulcanized to obtain the corrugated hose.
